(19) United States
(12) Patent Application Publication
(10) Pub. No.: US 2008/0260379 A1
(43) Pub. Date: Oct. 23, 2008

(54) Transceiver optical subassembly

(75) Inventor: Mark W. Beranek, Leonardtown, MD (US)

Correspondence Address: NAVAL AIR WARFARE CENTER AIRCRAFT;DIVISION OFFICE OF COUNSEL BLDG 435, SUITE A, 47076 LILJENCRANTZ ROAD UNIT 7, PATUXENT RIVER, MD, 20670, US

(73) Assignee: Department of the Navy

(21) Appl. No.: 11/789,120

(22) Filed: Apr. 19, 2007

(51) Int. Cl. H04B 17/00

(52) U.S. Cl. 398/21

(57) ABSTRACT

The subassembly includes a laser for emitting signals towards fibers to be monitored, a passive alignment carrier, a first photodetector for monitoring reflected laser signals from the fibers, a second photodetector for monitoring laser output power, and an optical fiber. The laser is disposed within the passive alignment carrier. The optical fiber is embedded in the passive alignment carrier, and has an angled fiber facet. The laser emits signals toward and through the angled fiber facet, whereby a portion of the laser signal illuminates the second photodetector, and another portion illuminates the fibers that are being monitored and reflects back to the first photodetector such that faults on the fibers can be detected.

### STATEMENT OF GOVERNMENT INTEREST

The invention described herein may be manufactured and used by or for the Government of the United States of America for governmental purposes without payment of any royalties thereon or therefor.

### BACKGROUND

The present invention relates to a fiber optic transceiver optical subassembly for use in fiber optic communication systems. More specifically, but without limitation, the present invention relates to an optical subassembly that is compatible with both laser diode and light emitting diode (LED) optical power monitoring, received photodetector optical power monitoring, and is capable of being used in conjunction with an optical beam splitting element inside a transceiver package.

Laser diode power monitoring is often used to control and monitor output power and modulation parameters of a laser diode inside a transmitter package. Laser power monitoring can also be used in conjunction with receiver signal strength indication to report the health characteristics in fiber optic links. In particular, laser power monitoring may be used to determine, isolate and find faults in avionics fiber optic links.

Previous methods to find faults in fiber optic cables utilize a silicon optical bench based digital laser transmitter optical subassembly that enables both digital optical communication and optical time domain reflectrometry. These optical subassembly configurations, however, do not allow vertical cavity surface emitting laser power monitoring or edge emitting laser diode power monitoring in optical subassemblies configured for isolating faults down to the fiber optic transmitter, receiver, and cable plant level.

For the foregoing reasons, there is a need for monitoring the optical power of both vertical cavity surface emitting and edge emitting laser diodes in optical subassemblies configured for isolating faults down to the fiber optic transmitter, receiver, and cable plant level.

### SUMMARY

The present invention is directed to a subassembly that meets the needs enumerated above and below.

The present invention is directed to a transceiver optical subassembly. The subassembly includes a laser for emitting signals towards fibers to be monitored, a passive alignment carrier, a first photodetector for monitoring reflected laser signals from the fibers, a second photodetector for monitoring laser output power, and an optical fiber. The laser is disposed within the passive alignment carrier. The optical fiber is embedded in the passive alignment carrier, and has an angled fiber facet. The laser emits signals toward and through the angled fiber facet, whereby a portion of the laser signal illuminates the second photodetector, and another portion illuminates the fibers that are being monitored and reflects back to the first photodetector such that faults on the fibers can be detected.

It is a feature of the present invention to provide a transceiver optical subassembly that allows vertical cavity surface emitting laser power monitoring and/or edge emitting laser diode power monitoring.

It is a feature of the present invention to provide a transceiver optical sub assembly that can accurately locate and isolate faults in fiber optic cables and/or fiber optic transceivers.

### DRAWINGS

These and other features, aspects and advantages of the present invention will become better understood with reference to the following description and appended claims, and accompanying drawings wherein:

FIG. 1 is a side view of an embodiment of the transceiver optical subassembly; and,

FIG. 2 is a side view of another embodiment of the transceiver optical subassembly.

### DESCRIPTION

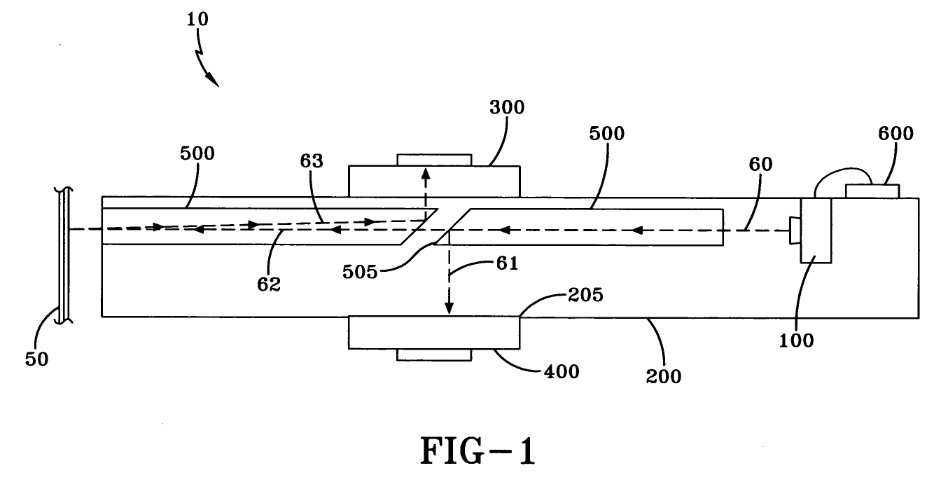

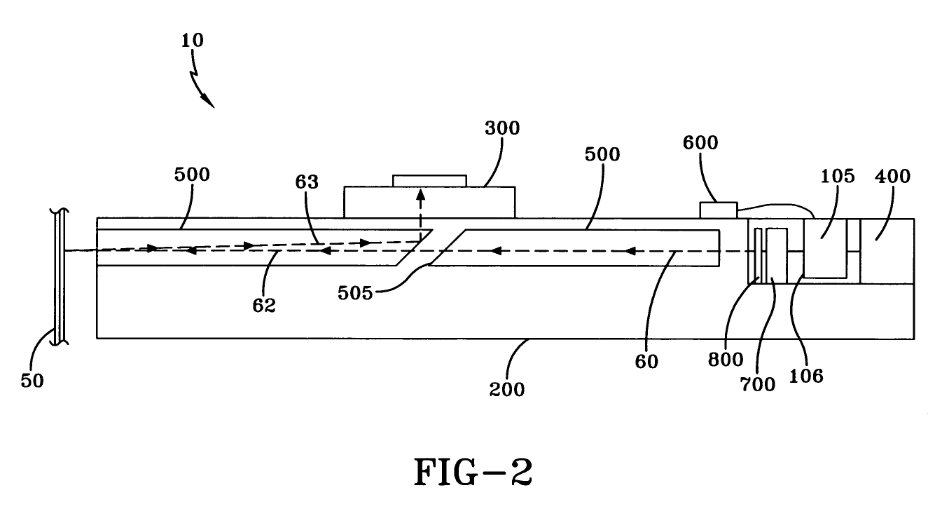

The preferred embodiments of the present invention are illustrated by way of example below and in FIGS. 1 and 2. As seen in FIG. 1, the transceiver optical subassembly 10 for laser power monitoring includes a laser 100 for emitting signals 60 towards a fiber or fibers 50 (or cables) to be monitored, a passive alignment carrier 200, a first photodetector 300 for monitoring reflected laser signals 63 from the fibers 50, a second photodetector 400 for monitoring laser output power, and an optical fiber 500. The laser 100 is disposed within the passive alignment carrier 200. The passive alignment carrier 200 may be disposed between the first photodetector 300 and the second photodetector 400. In the preferred embodiment, as seen in FIG. 1, the first photodetector 300 is disposed on top of the passive alignment carrier 200, while the second photodetector 400 is disposed on the bottom of the passive alignment carrier 200. The optical fiber 500 is embedded in the passive alignment carrier 200, and has an angled fiber facet 505. The laser 100 emits signals 60 toward and through the angled fiber facet 505, whereby a portion of the laser signal illuminates the second photodetector 400 (this portion of the laser signal 60 may be referred to as the second photodetector light portion 61), and another portion (this portion may be referred to as the fiber light portion 62) illuminates the fibers 50 that are being monitored and reflects back (the reflected signal from the fibers 50 being monitored may be referred to as the reflected signal 63) to the first photodetector 300 such that faults on the fibers 50 can be detected.

In the description of the present invention, the invention will be discussed in an avionic or aircraft fiber link environment; however, this invention can be utilized for any type of need that requires use of a transceiver optical subassembly. The transceiver optical subassembly 10 may be used, but without limitations, in military operations, communications, and various other electronic uses. Additionally, the same techniques and/or subassembly described here for laser diodes can be applied to surface emitting and edge emitting LEDs, as well as other types of lasers.

A laser 100 may be defined, but without limitation, as a light source producing, through stimulated emission, coherent, near monochromatic light, or light amplification by stimulated emission of radiation. One embodiment of the invention includes a laser 100 that is a vertical cavity surface emitting laser (VCSEL). A vertical cavity surface emitting laser (VCSEL) is typically, but without limitation, a specialized laser diode (a laser diode, also known as an injection laser or diode laser, may be defined, but without limitation, as a semiconductor device that produces coherent radiation (in which the waves are all at the same frequency and phase) in the visible or infrared (IR) spectrum when current passes through it). The transceiver optical subassembly 10 may also include a laser driver circuit 600. The laser driver circuit 600 provides current to the laser 100 such that the laser 100 emits signals 60, specifically optical signals 60 or light.

As shown in FIG. 2, another embodiment of the invention includes a laser 100 that is an edge emitting laser 105. The transceiver optical subassembly 10 may include a lens 700 and/or an isolator 800. The lens 700 focuses the optical signal 60 into the optical fiber 500 and/or to the fiber(s) 50 or cable(s) to be monitored. The isolator 800 prevents the reflected signal 63 or any other unwanted light from entering the front face 106 of the laser 105. A lens 700 and/or isolator 800 may be used in any embodiment, configuration or combination of the subassembly 10. In another embodiment, as shown in FIG. 2, the second photodetector may be disposed behind the edge emitting laser 105.

A passive alignment carrier 200 may be, but without limitation, defined as, a substrate with topographically etched features and metallizations that enable the automatic alignment of optical and optoelectronic components including optical fibers, laser diodes, LEDs, and photodetectors. The passive alignment carrier 200 may be a silicon optical bench or a silicon v groove passive alignment carrier. In the preferred embodiment the passive alignment carrier 200 includes a silicon substrate. In the embodiment of the invention shown in FIG. 1, the silicon substrate may also include an aperture 205 to allow easier lumenal or optical communication with the second photodetector 400. There also may be an additional aperture (not shown) to allow easier lumenal or optical communication with the first photodetector 300.

A photodetector may be defined, but without limitation, as a device capable of sensing light and converting it to electricity. The first photodetector 300 and/or the second photodetector 400 may be a positive-intrinsic-negative (p-i-n) photodetector, either front illuminated or back illuminated, a metal-semiconductor-metal (MSM), or an avalanche photodiode or photodetector. However, any type of photodetector can be utilized, as practicable.

An optical fiber may be defined, but without limitation as, a waveguide medium used to transmit information via light impulses rather than through the movement of electrons. The preferred optical fiber 500 is a multimode optical fiber transmitting in the about 800 to about 1600 nm range. The angled fiber facet 505 is a polished plane that is angled or oblique to the axis of the optical fiber 500, and acts as a beam splitter.

In operation, in the transceiver optical subassembly 10 shown in FIG. 1, the laser 100 emits light signals 60 through the optical fiber 500 (and along the axis of the optical fiber 500) and toward the fibers 50 or cables to be monitored. A portion of the light signal (the second photodetector light portion 61) passes through the angled fiber facet 505 and through the aperture 205 and illuminates the second photodetector 400. Another portion of the light signal (the fiber light portion 62) travels to the fibers 50 and then is reflected back (as the reflected laser signal 63) in the opposite direction and illuminates the first photodetector 300. The first photodetector 300 and the second photodetector 400 are in electronic communication with a processor that based on the illumination of the first and second photodetectors can determine if and where the fibers are experiencing a fiber optic link fault.

The transceiver optical subassembly 10 shown in FIG. 2, operates similarly except that the second photodetector 400 is disposed behind the laser 100 and monitors the output from the laser 100 from the back of the laser 100.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to a certain preferred embodiments thereof, other embodiments are possible. Therefore, the spirit and scope of the appended claims should not be limited to the description of the preferred embodiment(s) contained herein.

What is claimed is:

1. A transceiver optical subassembly for laser power monitoring, the subassembly comprising:
a laser for emitting signals towards fibers to be monitored;
a passive alignment carrier, the laser disposed within the passive alignment carrier;
a first photodetector for monitoring reflected laser signals from the fibers;
a second photodetector for monitoring laser output power;
an optical fiber, the optical fiber embedded in the passive alignment carrier, the optical fiber having an angled fiber facet, the laser emitting signals toward and through the angled fiber facet, whereby a portion of the laser signal illuminates the second photodetector, and another portion illuminates the fibers that are being monitored, and reflects back to the first photodetector such that faults on the fibers can be detected.

2. The transceiver optical subassembly of claim 1, wherein the laser is a vertical cavity surface emitting laser.

3. The transceiver optical subassembly of claim 1, wherein the passive alignment carrier is an optical bench.

4. The transceiver optical subassembly of claim 1, wherein the passive alignment carrier is a silicon v groove passive alignment carrier.

5. The transceiver optical subassembly of claim 1, wherein the first photodetector is disposed on top of the passive alignment carrier and the second photodetector is disposed on the bottom of the passive alignment carrier.

6. The transceiver optical subassembly of claim 1, wherein the laser is a vertical cavity surface emitting laser, and the passive alignment carrier includes a silicon substrate.

7. The transceiver optical subassembly of claim 6, wherein the subassembly further includes a laser driver circuit for providing current to the laser such that the laser can emit signals.

8. The transceiver optical subassembly of claim 7, wherein the first photodetector is a positive-intrinsic-negative (p-i-n) photodetector.

9. The transceiver optical subassembly of claim 8, wherein the first photodetector is front illuminated.

10. The transceiver optical subassembly of claim 8, wherein the first photodetector is back illuminated.

11. The transceiver optical subassembly of claim 7, wherein the second photodetector is a positive-intrinsic-negative (p-i-n) photodetector.

12. The transceiver optical subassembly of claim 11, wherein the second photodetector is front illuminated.

13. The transceiver optical subassembly of claim 11, wherein the second photodetector is back illuminated.

14. The transceiver optical subassembly of claim 1, wherein the optical fiber is a multimode optical fiber.

15. The transceiver optical subassembly of claim 14, wherein the optical fiber transmits in the about 800 to about 1600 nm range.

16. The transceiver optical subassembly of claim 1, wherein the subassembly further includes a lens for focusing the laser signal.

17. The transceiver optical subassembly of claim 1, wherein the subassembly further includes an isolator for preventing light from entering the laser.

18. A transceiver optical subassembly for laser power monitoring, the subassembly comprising:
a laser for emitting signals towards fibers to be monitored;
a passive alignment carrier, the laser disposed within the passive alignment carrier;
a first photodetector for monitoring reflected laser signals from the fibers, the first photodetector disposed on top of the passive alignment carrier;
a second photodetector for monitoring laser output power, the second photodetector disposed behind the laser;
an optical fiber, the optical fiber embedded in the of the passive alignment carrier, the optical fiber having an angled fiber facet, the laser emitting signals toward and through the angled fiber facet, whereby a portion of the laser signal illuminates the fibers that are being monitored, and reflects back to the first photodetector such that faults on the fibers can be detected.

19. The transceiver optical subassembly of claim 18, wherein the subassembly further includes a lens for focusing the laser signal.

20. The transceiver optical subassembly of claim 20, wherein the subassembly further includes an isolator for preventing light from entering the laser.
